(19) United States
(12) Patent Application Publication
(10) Pub. No.: US 2025/0251842 A1
(43) Pub. Date: Aug. 7, 2025

(54) A Portable Information Terminal Device

(71) Applicant: Kei OSUMI, Shinjuku-ku (JP)

(72) Inventor: Kei OSUMI, Shinjuku-ku (JP)

(21) Appl. No.: 19/034,810

(22) Filed: Jan. 23, 2025

(30) Foreign Application Priority Data
Feb. 1, 2024 (JP) 2024-014493

(51) Int. Cl. G06F 3/04812; G06F 3/0485; G06F 3/0488

(52) U.S. Cl. CPC G06F 3/04812; G06F 3/0485; G06F 3/0488

(57) ABSTRACT

A portable information terminal device is provided that has a display screen, a function for displaying data on the display screen, and an operation element A that is displayed on the display screen and operates the display of the data, and whose display data can be viewed and edited. The portable information terminal device has a function of displaying, on the display screen, marks that allow new data to be added to all positions to which data can be added among a plurality of data (items) arranged on the display screen when the operation element A is touched. The marks are a cursor and an operation element B, and the operation element B is in the form of a button. The portable information terminal device has a function of adding or writing data at a desired position by touching the operation element B at the desired position for adding data. It has a function of making the mark disappear by touching a part of the display screen other than the operation element B.

### CROSS REFERENCE TO RELATED APPLICATIONS

This application claims priority to Japanese Patent Application No. 2024-014493, filed on Feb. 1, 2024, which is expressly incorporated herein by reference in its entirety.

### TECHNICAL FIELD

The present invention relates to applications and functions of writing or adding new data to data displayed on a display screen of a portable information terminal device.

### BACKGROUND ART

In portable information terminal devices such as a smartphone, multiple character data and image data arranged vertically in a display screen of the portable information terminal devices are viewed and edited. FIG. 8 is a figure showing an example of an application that allows users to view, edit, and add multiple data conventionally used in the smartphone. When this application is started, the display shown in FIG. 8 appears on the display screen 51 of the smartphone. In FIG. 8, a button 52, which is an operation element, is arranged at the lower part of the screen 51, and data 53 (53-1, 53-2, 53-3) are shown at the upper part of the screen 51. When the button 52 is touched, a keyboard for input, which is called an input keyboard or an entry keyboard, is displayed in the screen and new data can be written and added. However, the new data can always only be written and added at the top of the display screen 51, i.e., only directly above the data 53-3 (character string <CCC . . . >). (See https://play.google.com/store/apps/details?id=com.google.android.apps.tasks)

Since a keyboard is simply displayed when the conventional button is touched, there is a problem that new data can be written or added only at a predetermined position in a vertically arranged data, for example, at the top or bottom of a vertically arranged data or data row. Accordingly, to place data at any position in the display screen, new data must be written or added at a predetermined position and then moved to a desired position. For example, in the example shown in FIG. 8, since the data added at the top is selected and then moved by dragging to the desired position, it is troublesome, laborious, and time-consuming. If the data to be added is long or the list of data is long, it will be very time-consuming, and there is also the problem that thinking is not organized because the list is traced back each time when an input is executed.

### SUMMARY

The present invention relates to a data control function or method of a display screen in a portable information terminal device such as a smartphone having a display screen with a touch sensor function. The present invention provides a function of writing, describing or adding new data to the data displayed on the display screen by an easy and simple operation. The present invention has the following features.
(1) The present invention is a portable information terminal device that has a display screen, a function for displaying data on the display screen, and an operation element (operation element A) that is displayed on the display screen and controls or operates the display of the data, and that can be viewed and edited. The present invention also provides the portable information terminal device having a function of displaying marks on the display screen that allow new data to be added to all positions where data can be added or written among a plurality of data (items) arranged on the display screen by touching the operation element A. The present invention also has a function of scrolling the data on the display screen when a part of the display screen other than the operation element A is touched and dragged upward or downward. The operation element A is in the form of a button.
(2) In addition to the above (1), in the present invention, the marks are a cursor (line) and an operation element (operation element B), and the operation element B is in the form of a button. In the present invention, when the operation element B at a desired position for adding or writing data in the display screen is touched, new data can be added or written at the desired position. When the operation element B at a desired position is touched, an input keyboard appears on the display screen, and new data can be added or written at the desired position. The portable information terminal of the present invention has a function of causing the mark to disappear by touching a portion of the display screen other than the operation element B.

### Advantageous Effect of the Invention

According to the present invention, new data can be written, described or added at any or arbitary desired position in the display screen by an easy and simple operation of an operation element such as a button or the like. By touching operation element A such as the button A, marks such as cursor lines and operation element B such as button B can be made to appear at all positions between data strings, allowing the user to immediately know the positions where data can be added. Furthermore, by touching operation element B such as the button B at the position where data is to be (should be) added, a keyboard appears and new data can be added or written to the position using the keyboard. In this way, since new data can be added or written directly to a desired position by a very simple operation of simply touching the operation element, new data can be written or added simply and quickly with minimal effort.

### BRIEF DESCRIPTION OF THE DRAWINGS

FIG. 1 is a block diagram showing the schematic functions of the portable information terminal device of the present invention.

FIG. 2 is a diagram showing multiple rows of data vertically aligned in the data display screen of a smartphone (viewing mode or view mode).

FIG. 3 is a diagram showing the state of the data display screen of the smartphone displayed when the button is touched (with a finger, touch pen, or the like) (data adding (or addition) mode).

FIG. 4 is a diagram showing a flowchart for explaining an example of the data addition processing method of the present invention.

FIG. 5 is a diagram showing an embodiment of a display screen displayed when the application of the present invention is started (viewing mode).

FIG. 6 is a diagram showing the display screen displayed after the (plus) button A is touched or pressed with a finger or the like.

FIG. 7 is a diagram showing a data input screen that is displayed on the display screen when button B is touched.

FIG. 8 is a diagram showing an example of an application that is conventionally used in a smartphone and allows the users to view and edit multiple data.

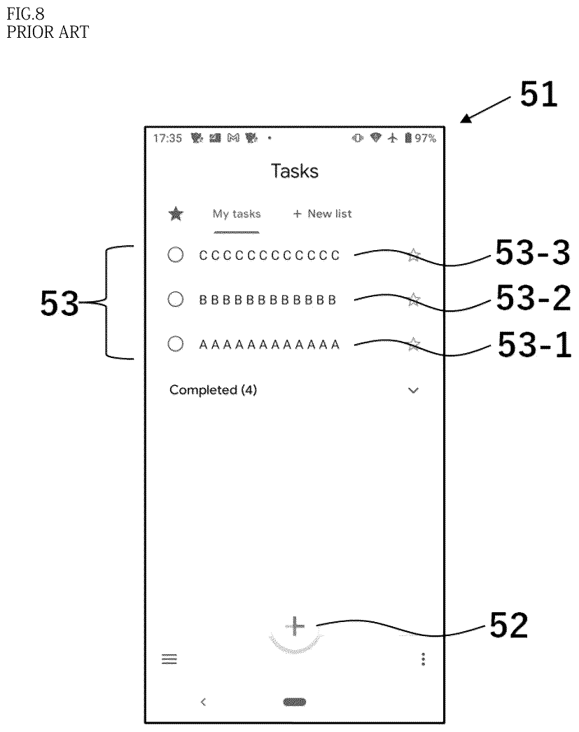

### DETAILED DESCRIPTION

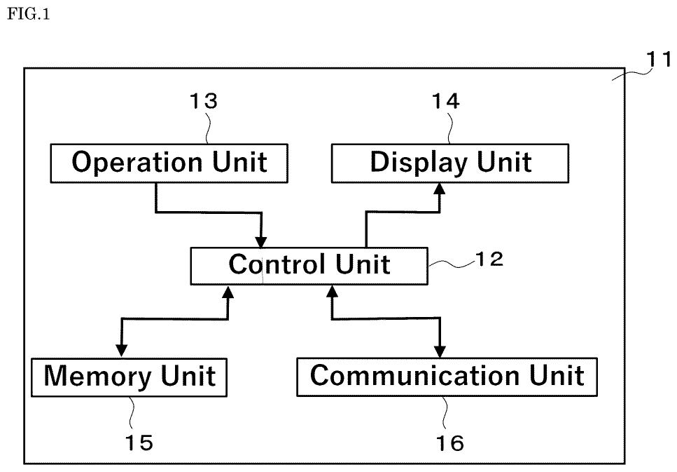

This invention provides a function to easily add new data to data displayed on a display screen or to easily write or describe or add on a display screen in portable information terminal devices such as smartphones, portable game consoles, tablet terminals, or media players that have touch screen displays (or referred to as display screens). That is, the portable information terminal device of the present invention is equipped with an application (software) for executing various functions. And using their functions, new data is simply written or added to the data displayed on the display screen. FIG. 1 is a block diagram showing a schematic system of the portable information terminal device used in the present invention. Alternatively, FIG. 1 may be called a block diagram showing a schematic system of the application (software) installed in the portable information terminal device. The portable information terminal device 11 mainly comprises a control unit 12, an operation unit 13, a display unit 14, a memory unit 15, and a communication unit 16. The display unit 14 comprises a view (display) of a display screen, for example, data such as characters and images and operation elements such as buttons and icons (e.g., GUI (Graphical User Interface)). The display screen is a liquid crystal display screen, or an organic EL (Electro Luminescence) display screen, and the view of the display screen is displayed on the display screen according to the commands of the control unit 12. The operation unit 13 comprises touch sensors of various types, and detects a contact of an operator's finger, touch pen, or the like with the display screen of the display unit 14. The contact signal is sent to the control unit 12 as an operation input. The operation element (or also referred to as a manipulator or an actuator) can also be moved up and down in the display screen by a command of the control unit 12 in response to the operator's drag operation, which is an operation of tracing the display screen while touching the operation element on the display screen.

The control unit 12 comprises a microprocessor such as a CPU (Central Processing Unit) or a GPU (Graphics Processing Unit), which operates according to a program stored in the memory unit 15 to give commands to each unit of the portable information terminal device and control it. For example, the control unit 12 gives commands to the display unit 14 in response to an operation input of the operation unit 13 to display various views on the display screen or to control an operation of the display. Also, the control unit 12 gives commands to the display unit 14 using information from the memory unit 15 or the communication unit 16 in response to an operation input of the operation unit 13 to perform various views on the display screen or to control an operation of the display. The memory unit 15 is, for example, an IC memory and stores various information used by the information terminal device 11. Also, the memory unit 15, for example, stores programs for functioning the control unit 12, and the memories stored in the memory unit 15 are played back as needed by commands of the control unit 15. The communication unit 16 has the function to acquire information from the outside and to transmit information to the outside through various communication methods. For example, an application software for executing the invention on the portable information terminal device 11 can be downloaded through the communication unit 16. External information can be obtained by the communication unit 16 and stored by the memory unit 15 and displayed on the display screen by the display unit 14, under the control of the control unit 12.

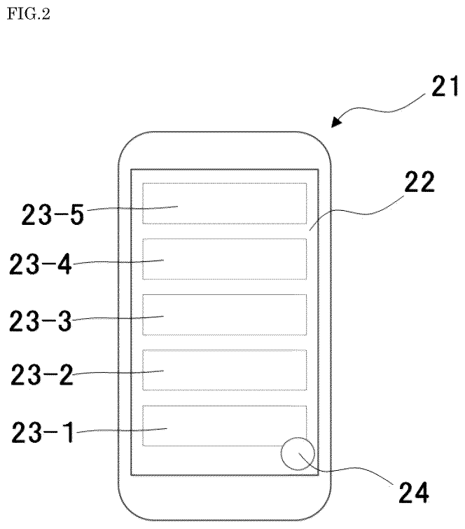

When the application (software) of the present invention is launched, data of text and image, etc. or a list of data consisting of such data (or referred to simply as data, or data string or data row) appear on the display screen of the portable information terminal device such as a smartphone, and buttons and other also operation elements, which are also hereafter referred to simply as buttons or button, also appears on the display screen. When the application is launched, the button is usually located on the bottom right side of the screen, but the location of the button on the screen need not be limited. That is, the present invention provides a portable information terminal device having a display screen, and application software having a function of displaying data on the display screen and a function of viewing and editing the data, and when the application software is started, a number of data items are displayed on the display screen, along with an operation element A for controlling or operating the display of the data. Here, the application (software) of the present invention, like other application software, is displayed as, for example, an icon on the display screen of the portable or mobile information terminal device at start-up or in standby mode, and the application (software) of the present invention can be launched by touching or tapping the icon with a finger or the like. FIG. 2 shows a plurality of data (rows) arranged vertically (in the vertical direction) in the display screen 22 of a smartphone 21, which is a viewing mode. Here, the vertical direction is usually the longitudinal direction of the substantially rectangular-shaped display screen 22, but it may also be the short side direction when the display screen 22 of the smartphone 21 is placed horizontally. When the application (software) of the invention is started on the smartphone 21, the button 24, which may be written as a button A or an operation element A or an addition button A, which position is not particularly limited. When the application of the invention is started on the smartphone 21, a number of data (rows), which are data 23-1, 23-2, 23-3, 23-4, 23-5, etc., are displayed in the display screen 22. Launching the application can be performed from the normal selection of the application on the smartphone 21. This application software may be obtained externally through the communication unit 16, or it may be once stored in the memory unit 15 after it is obtained externally.

Data are, for example, characters, text, graphics, images, etc. Data also includes groups of individual data, for example, text, descriptions, images and their descriptions, etc. Data string(s) or data row(s) are series of data, which may also be referred to simply as data. In addition to data, an operation element 24 such as a button is also displayed to operate in the display screen. In FIG. 2, a button 24 is displayed between the data in the lower right corner of the vertically long display screen 22, but it may be displayed in any other position in the display screen. In FIG. 2, data also exists outside (upper or lower) of the display screen 22. Their data can be displayed on the display screen 22 by scrolling up or down. For example, data may exist on the upper outer side of data 23-5 at the top edge of the screen 22 and on the lower outer side of data 23-1 at the bottom edge of the screen 22. The data displayed on the screen 22 and the data existing outside of the screen 22 are stored in the memory unit 15, and their data are displayed on the display unit 14 under a command of the control unit 12. Naturally, if there is no data before data 23-5 or after data 23-1 in the memory unit 15, no data exists outside the top or bottom edge of the display screen 22.

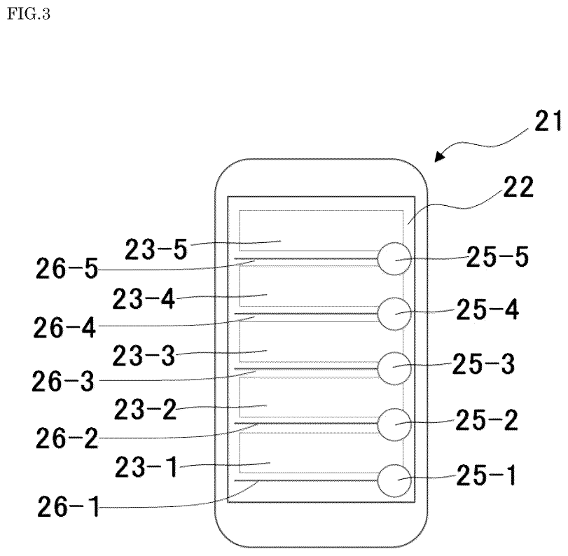

FIG. 3 is a diagram showing the state (data addition mode or data edit mode) of the display screen of the smartphone 21 at the time when or after touching (including when touching and then releasing the touch) the button A (operation element A) 24 shown in FIG. 2 (with a finger, a touch pen, etc.). When the button A 24 shown in FIG. 2 is touched with a finger or the like, the display mode switches to a data addition mode, and a cursor (straight (or horizontal) line) and an operation element (button) are displayed at all (or multiple) positions where data can be added or written. For example, in FIG. 3, a cursor (straight line) 26 (26-1 to 5) and an operation element (also referred to as operation element B or button B) 25 (25-1 to 5) are displayed between data (columns, strings, or rows) 23 (23-1 to 5) displayed on the display screen 22, or below the data (columns) 23 (23-1 to 5), or above the data (columns) 23 (23-1 to 5). Here, the cursor is shown, but it may be a pointer or various marks (including a cursor). The operation element B (button B) is also shown as a round button, but it may be a button-shaped mark of various shapes (for example, square, triangular, or star-shaped). Furthermore, the buttons B 25 (25-1 to 25-5) are arranged on the right side of the display screen, but may be arranged in any position, such as on the left side or near the center, as long as it is clear that the position is one where data can be added.

In FIG. 3, buttons B (25-1 to 25-5) are positioned on all the cursors (26-1 to 26-5) at the locations where data can be added or written, and data can be added or written at the cursors (26-1 to 26-5) by using the buttons B (25-1 to 25-5). And cursors (26-1 to 26-5) are positioned at all the locations where data can be added or written. That is, in FIG. 3, the locations where data can be added are below data 23-1, between data 23-1 and data 23-2, between data 23-2 and data 23-3, between data 23-3 and data 23-4, and between data 23-4 and data 23-5. And cursors 26-1 to 26-5 are displayed respectively. Also, buttons 25-1 to 25-5 are displayed or placed respectively on the right side of the cursors. When a part of the display screen other than the buttons B (25-1 to 25-5) is touched, the marks (cursors 26, buttons B25) are erased or disappear and the display mode is switched to the browsing (or viewing) mode shown in FIG. 2. Although the button A 24 is not shown (illustrated) in FIG. 3, the button A 24 may remain displayed on the display screen 22. The operation unit 13 detects that the button A24 has been touched, and sends the detection signal to the control unit 12. The control unit 12 retrieves mark (cursor or button, etc.) information from the memory unit 15 and issues a command to the display unit 14 to display marks, for example, a cursor, etc. 26 (26-1 to 5) and an operation element (button B) 25 (25-1 to 5), at a predetermined position on the display screen 22.

In FIG. 2, when a part of the display screen 22 other than button A (also called a mark display button or a data addition button) is touched and dragged upward, the display screen 22 scrolls upward so that data on the lower side of the display screen 22, which is data below data 23-1, can be displayed on the display screen 22. Alternatively, when a part of the display screen 22 other than the button A is touched and dragged downward, the display screen 22 scrolls downward and data on the upper side of the display screen 22, which is data above data 23-5, can be displayed on the display screen 22. In this manner, by touching a portion of the display screen 22 other than the button A, the data on the display screen 22 can be scrolled up and down, allowing various data to be viewed or the order of the data to be changed. The data can be replaced, for example, as follows. The two data can be swapped by simultaneously touching each data with two fingers or two touch pens or the like.

In FIG. 3, when a portion of the display screen 22 other than the buttons B 25 (25-1 to 25-5) is touched or after touching and then releasing the touch, the display mode is switched to the browsing (or viewing) mode shown in FIG. 2. In FIG. 3, if there is no place to add or write data in the data on the display screen 22, or if the location where data should be added or written is not displayed on the display screen 22, the user can return to the viewing mode shown in FIG. 2 and scroll the data up and down to find a location where data should be added or written. Alternatively, after simply scrolling the data up and down, the user may touch the button A 24 to switch to the data addition mode shown in FIG. 3. Alternatively, in FIG. 3, by touching and dragging the button B 25 (25-1 to 5) up or down, the user can scroll up or down the display on the display screen and display data on the upper or lower outside of display screen 22. In this case, the cursor line and the button B are naturally displayed between the newly displayed data (columns). When the user touches (or touches and releases) the button B 25 (25-1 to 5) (or any of them), a keyboard appears on the display screen, then the user can add or write data using the keyboard at the cursor position where the button B 25 (25-1 to 5) is placed. For example, in FIG. 3, when the button B 25-3 is touched or is touched and released, a keyboard appears on the display screen. And new data can be added or written using the keyboard at the cursor 26-3 position where the button B 25-3 is placed.

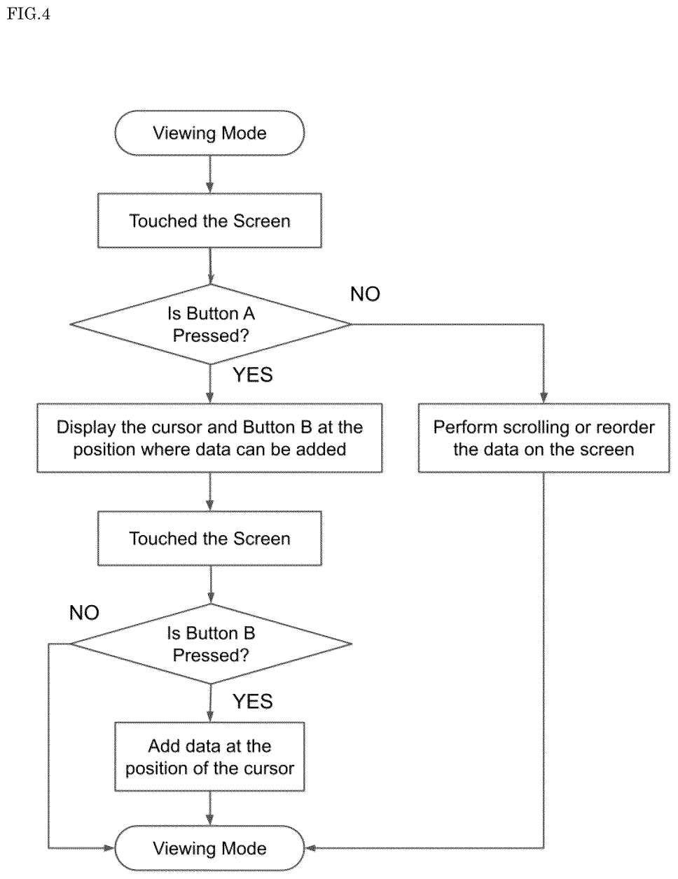

FIG. 4 is a flowchart showing an example of a data addition processing method according to the present invention. When the smartphone starts up, the display screen in browsing mode appears as shown in FIG. 2. When the display screen is touched, it is determined (by the control unit 12) whether or not button A is touched (or pressed). When button A is touched or pressed, a cursor and a button B are displayed at (all) the locations where data can be added. That is, the display screen becomes one in the data addition mode. When the display screen in the data addition mode is touched, it is determined (by the control unit 12) whether or not button B is touched (or pressed). When button B at a position where data is to be (should be) added is pressed (or touched), the data can be added to the location of the cursor at the position where the data is to be added. Regarding the data addition, when button B is touched (or the touch is released), a keyboard appears on the display screen, and the user can add or write new data using the keyboard. After the data is added or written, the display returns to the viewing mode, or if button B is not pressed (or touched) and a part of the display screen other than button B is touched, the display also returns to the viewing mode. Furthermore, when button A is not touched and a portion of the display screen other than button A is touched, the data on the display screen can be scrolled or the order of the data can be changed. Once they are complete, the display screen goes into a viewing mode.

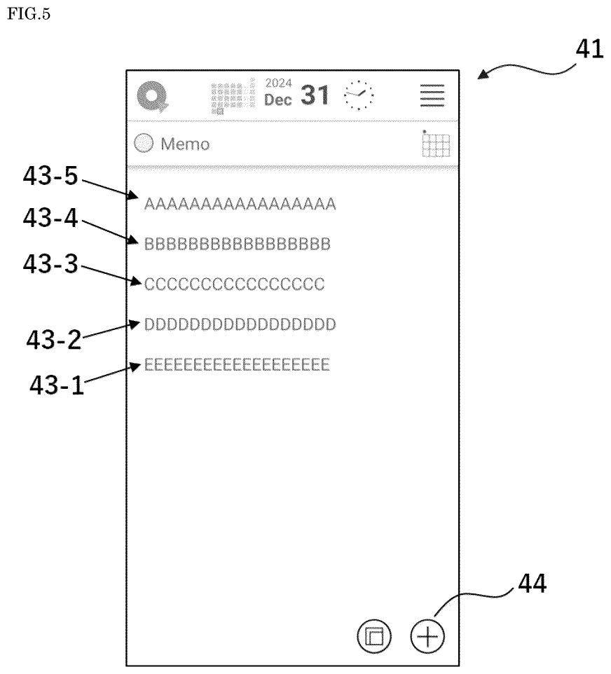

FIG. 5 is a diagram showing an example of a display screen (viewing mode) displayed when the application of the present invention is started. On the display screen 41 in the browsing (or viewing) mode, an operation element A (button A) 44 and data 43 (43-1 to 43-5) are displayed. The operation element A (or button A) 44 s represented by a plus (+) button. The data 43 (43-1 to 43-5) are arranged vertically in five columns on the display screen 41. That is, the data in the five columns are 43-1 (EEEE . . . ), 43-2 (DDDD . . . ), 43-3 (CCCC . . . ), 43-4 (BBBB . . . ), and 43-5 (AAAA . . . ).

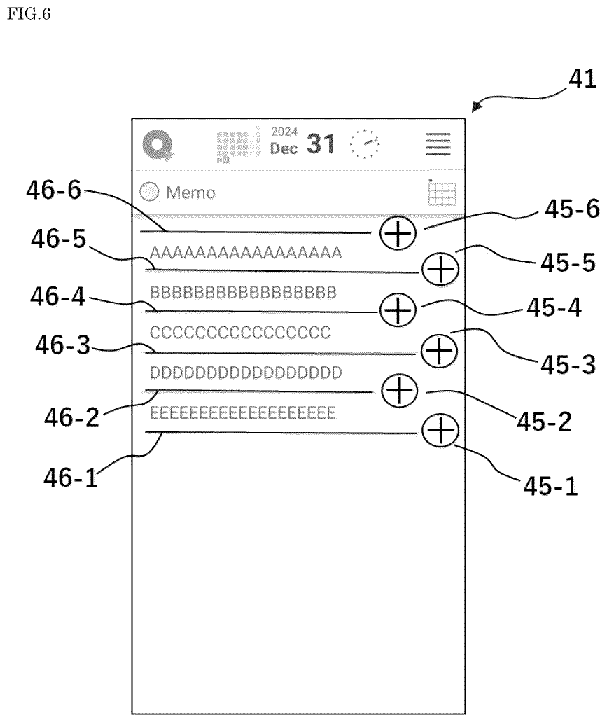

FIG. 6 is a diagram showing the display screen immediately after the (plus) button A 44 is touched (or pressed) with a finger or the like. Cursor lines 46 (46-1 to 46-6) are placed between or above or below the data 43 (43-1 to 43-5). Additionally, (plus) buttons B 45 (45-1 to 6) are arranged on and to the right of the cursor lines 46 (46-1 to 6). The positions where the cursor lines 46 (46-1 to 46-6) are placed are the positions where data can be added (or written). Among these cursor lines 46 (46-1 to 46-5), by touching (or pressing) the (plus) button B 45 on the cursor arranged at the place where data is to be added (or written), new data can be added (or written). For example, if the user wishes to add (or write) data between data 43-2 (DDDD . . . ) and data 43-3 (CCCC . . . ), the user touches (or presses) button B 45-3 on cursor line 46-3.

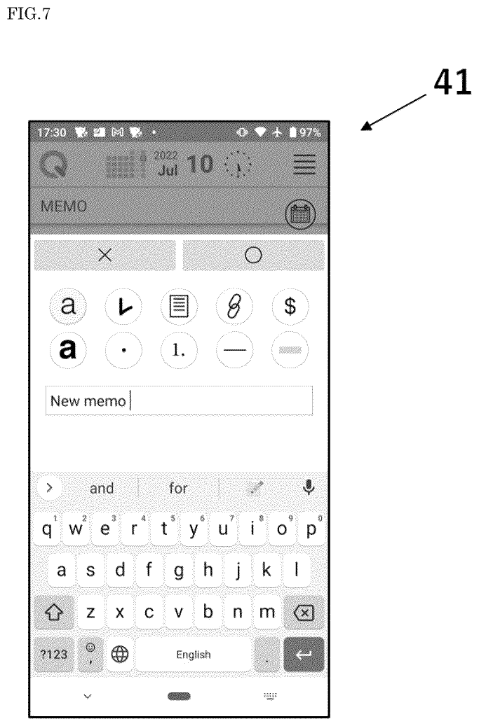

FIG. 7 is a diagram showing a data input screen that is displayed on the display screen when button B is touched or when the touch on button B is released. A keyboard, which is called input or entry keyboard, having various key is displayed on the display screen 41 of the smartphone. The keyboard has, for example, alphabetical keys, numeric keys, command keys, control keys, input or entry keys, etc. Using this keyboard (i.e., by touching the keys, etc.), various characters and symbols can be input. Here, “New Memo” is entered. It is also possible to insert images and other items. By executing input here, “new memo” can be added (or written) at the position where data is to be added, for example, between data 43-2 (DDDD . . . ) and data 43-3 (CCCC . . . ). In FIG. 7, input can be executed by touching or pressing the input or entry key on the keyboard, for example. When the input is executed, the new data is added at the desired position, and then the display screen changes to the viewing mode screen shown in FIG. 5 or to the data addition mode (edit mode) screen shown in FIG. 6. For example, after new data is added or written, the display screen of the portable information terminal device becomes a screen having the operation element A and data including the new data.

As described above in detail, the present invention relates to a mobile or portable information terminal device (e.g., a smartphone) having a data addition function or a data edit function. By using the present invention, new data can be easily added or written to any (arbitrary) position of data displayed on the display screen of a mobile information terminal device such as a smartphone. For example, while a conventional operation element such as a button only displays a keyboard when touched, the operation element (button, etc.) of the present invention displays a mark (cursor, etc.) for designating the position where data is to be added. As a result, new data can be added or written to any (arbitrary) desired location, including data outside the display screen, with a single operation. If a content described and explained in a certain part of the specification can be explained without contradiction in other part of the specification, it goes without saying that the content can be applied to the other part of the specification. Also, it goes without saying that the contents of the examples and embodiments described in the present application document can be used in combination with the contents of other examples and embodiments. Furthermore, it goes without saying that the embodiment is an example and can be modified in various ways without departing from the scope of the present invention, and the scope of rights of the present invention is not limited to the embodiments.

### INDUSTRIAL APPLICABILITY

The present invention can also be applied to other devices having a touch panel, for example, a personal computer, various measuring devices, and the like.

What is claimed is:

1. A portable information terminal device comprising:
a display screen;
a function of displaying a data on the display screen;
an operation element A for operating the display of the data; and
a function of viewing and editing the data,
the device having a function of displaying on the display screen a mark that allows new data to be added or written to all positions where data can be added or written among multiple data items arranged on the display screen by touching the operation element A.

2. The portable information terminal device according to claim 1,
the device having a function of scrolling data on the display screen when a portion of the display screen other than the operation element A is touched and dragged upward or downward.

3. The portable information terminal device according to claim 1, wherein the operation element A is in the form of a button.

4. The portable information terminal device according to claim 1, wherein the marks are a cursor line and an operation element B.

5. The portable information terminal device according to claim 4, wherein multiple data items are arranged vertically on the display screen, and the cursor lines are placed between and above and below the data items, and the operation elements B are positioned to the right side of all the cursor lines.

6. The portable information terminal device according to claim 4, wherein the operation element B is in the form of a button.

7. The portable information terminal device according to claim 4,
when the operation element B is touched while at a position where data is to be added, the device having a function of adding or writing new data at the position.

8. The portable information terminal device according to claim 4,
when a plurality of operation elements B are displayed on the display screen, the device having a function of adding or writing new data at a desired position by touching the operation element B at the desired position for adding or writing data.

9. The portable information terminal device according to claim 4,
when the operation element B is touched while at a position where data is to be added,
an input keyboard appears on the display screen, and
the device having a function of adding or writing new data at the position using the input keyboard.

10. The portable information terminal device according to claim 9,
wherein the input keyboard has an enter key,
the device having a function of adding or writing data at the desired position by touching or pressing the enter key.

11. The portable information terminal device according to claim 10, after new data is added or written, the device having a function that the display screen of the portable information terminal device becomes a screen having the operation element A and data including the new data.

12. The portable information terminal device according to claim 4,
the device having a function of causing the mark to disappear by touching a portion of the display screen other than the operation element B.
